(19) United States
(12) Patent Application Publication
(10) Pub. No.: US 2008/0023390 A1
(43) Pub. Date: Jan. 31, 2008

(54) Multiple Cartridge and Cartridge Array Frame

(75) Inventors: Jeiji Shigesada, Kanagawa (JP); Morio Fujiwara, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FujiFilm Corporation, Tokyo (JP)

(21) Appl. No.: 11/661,768

(22) PCT Filed: May 19, 2005
(86) PCT No.: PCT/JP05/09594

§ 371 Date: Mar. 5, 2007

(30) Foreign Application Priority Data
Sep. 30, 2004 (JP) 2004-286233

(51) Int. Cl. B01D 25/02; B01L 3/00

(52) U.S. Cl. 210/321.84; 210/455

(57) ABSTRACT

In order to prevent the waste of porous membrane cartridges (1) of the present invention, a multiple cartridge (A) is the cartridge that plurally provides the porous membrane cartridges side by side by a link piece (5), each of which has a tubular barrel (10) having openings (11a, 11b) at a top end portion (13) and rear end portion thereof; a cap (20) that is formed like a tube having a fit-in portion (22) for fitting outside the top end portion, and abuts with an opening edge (14) of the top end portion, and has a sandwich face (24) for sandwiching a porous membrane (F) between the cap and the barrel; and the porous membrane sandwiched between the opening edge of the barrel and the cap.

### TECHNICAL FIELD

The present invention relates to a multiple cartridge having a plurality of porous membrane cartridges used for filtrating liquid and the like and a cartridge array frame for arraying the multiple cartridge.

### BACKGROUND ART

A porous membrane is widely used in a laboratory and a factory for filtrating liquid and adsorbing a specific substance in liquid. And in utilizing the porous membrane for such the purpose, it is necessary to hold the porous membrane on the way of a passage where the liquid passes. As this holding method is generally used a method of sandwiching the porous membrane between two members having the passage where the liquid passes, and thus holding it.

Because such a porous membrane is generally used in an accurate experiment and measurement, clean one is requested, and if used once, it is usually changed. Therefore, in a point of cleanliness and that of usability in use, it is convenient to make a cartridge a state of holding the porous membrane and being able to pass liquid. As such a porous membrane cartridge is known such a nucleic acid refining unit described in paragraphs 0010 to 0020 and FIG. 1 of JP-A-2002-345465.

In this connection, generally in an extraction process of nucleic acids and the like and in an amplification process and an analysis process thereafter are used porous membrane cartridges in a multiple cartridge of format of 96 pieces of 8 pieces×12 rows. Consequently, although it can be thought to integrally mold the porous membrane cartridges into the multiple cartridge of format of 96 pieces, a metal mold and working equipment become a large scale, and it results in a cost increase. Furthermore, when using a part of the porous membrane cartridges out of the multiple cartridge of format of 96 pieces, there exists a problem that the porous membrane cartridges not used become wasteful.

### DISCLOSURE OF THE INVENTION

In order to solve the problem, a multiple cartridge of the present invention is configured as follows:

That is, a multiple cartridge of the invention is the cartridge that plurally comprises porous membrane cartridges provided side by side in a row and integrally configured for holding each porous membrane within a tube of a tubular body thereof, which has an opening at a top end portion and rear end portion thereof.

In accordance with such the multiple cartridge is used the multiple cartridge comprising porous membrane cartridges corresponding to a number of the porous membrane cartridges to be used, and thereby the porous membrane cartridges not used do not wastefully occur out of the multiple cartridge.

A porous membrane cartridge may comprise a tubular barrel having each opening at a top end portion and rear end portion thereof, a cap that is formed like a tube having a fit-in portion for fitting outside the top end portion, and abuts with an opening edge of the top end portion and has a sandwich face for sandwiching a porous membrane between the barrel and the cap; and the porous membrane sandwiched between the opening edge of the barrel and the cap.

In addition, an adjacent portion of each porous membrane cartridge may also be linked by a link piece along a longitudinal direction of the tubular body.

In addition, an adjacent portion of each porous membrane cartridge may also be linked by a link piece along a longitudinal direction of the barrel or the cap.

In addition, a connection portion of each porous membrane cartridge may also be thickly formed.

In addition, each adjacent tubular body may also be integrally molded.

In addition, each adjacent barrel or each adjacent cap may also be integrally molded.

In addition, in order to solve the problem, a cartridge array frame of the present invention is configured as follows:

That is, the cartridge array frame of the present invention is the frame for arraying multiple cartridges in a plurality of rows and comprises a frame body having a rectangular opening, whose one pair of sides corresponds to a length in a horizontal direction of the multiple cartridge; and a plurality of holding portions that are provided inside the other pair of sides of the opening and hold side portions of the multiple cartridge.

In accordance with the present invention it can be prevented that the porous membrane cartridges not used become wasteful.

In addition, it is not troublesome to insert a multiple cartridge in a frame thereof, and a simple structural frame can be obtained for inserting porous membrane cartridges.

### BRIEF DESCRIPTION OF DRAWINGS

FIG. 1(a) is a front view of a multiple cartridge related to a best mode for embodying the present invention; FIG. 1(b) is a top view of the multiple cartridge related to the best mode for embodying the present invention; and FIG. 1(c) is a perspective view of the multiple cartridge related to the best mode for embodying the present invention.

FIG. 2 is a perspective view showing a part of the multiple cartridge related to the best mode for embodying the present invention.

FIG. 3 is a perspective view showing a variation example of a multiple cartridge.

FIG. 4 is a perspective view showing a variation example of a multiple cartridge.

FIG. 5 is an exploded perspective view of a porous membrane cartridge related to the best mode for embodying the present invention.

FIG. 6 is a section view of a porous membrane cartridge related to the best mode for embodying the present invention.

FIG. 7 is an enlarged section perspective view of a cap related to the best mode for embodying the present invention.

FIG. 8 is a perspective view of a cartridge array frame related to the best mode for embodying the present invention.

FIG. 9 is a perspective view of a cartridge array frame related to the best mode for embodying the present invention.

FIG. 10 is a perspective view showing a variation example of a cartridge array frame.

FIG. 11 is a perspective view showing a variation example of a cartridge array frame.

### MODE(S) FOR CARRYING OUT THE INVENTION

Next will be described a best mode for embodying the present invention, referring to drawings as needed. Meanwhile, in the best mode for embodying the invention, although a case is described that a multiple cartridge is used in an extraction of nucleic acids as an application thereof, the application is not limited thereto.

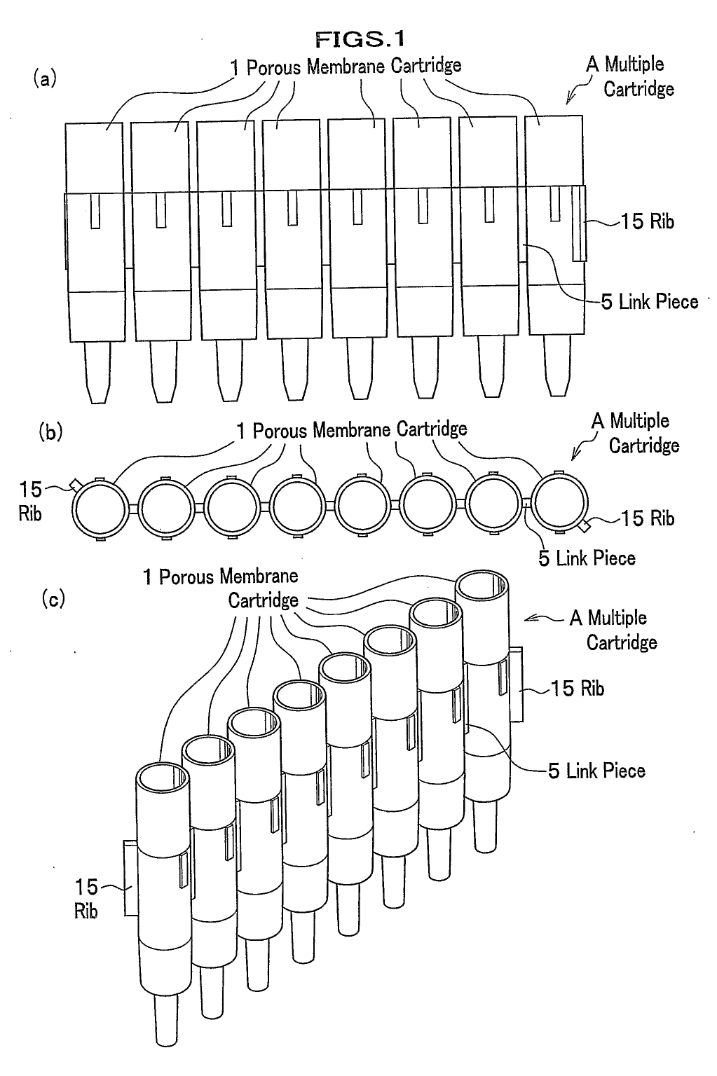

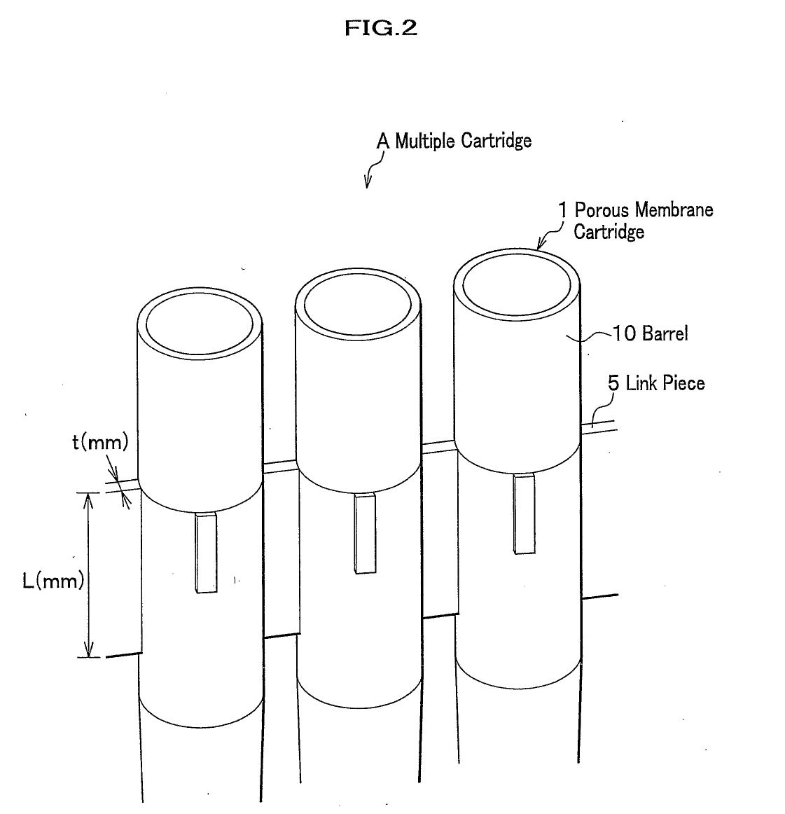

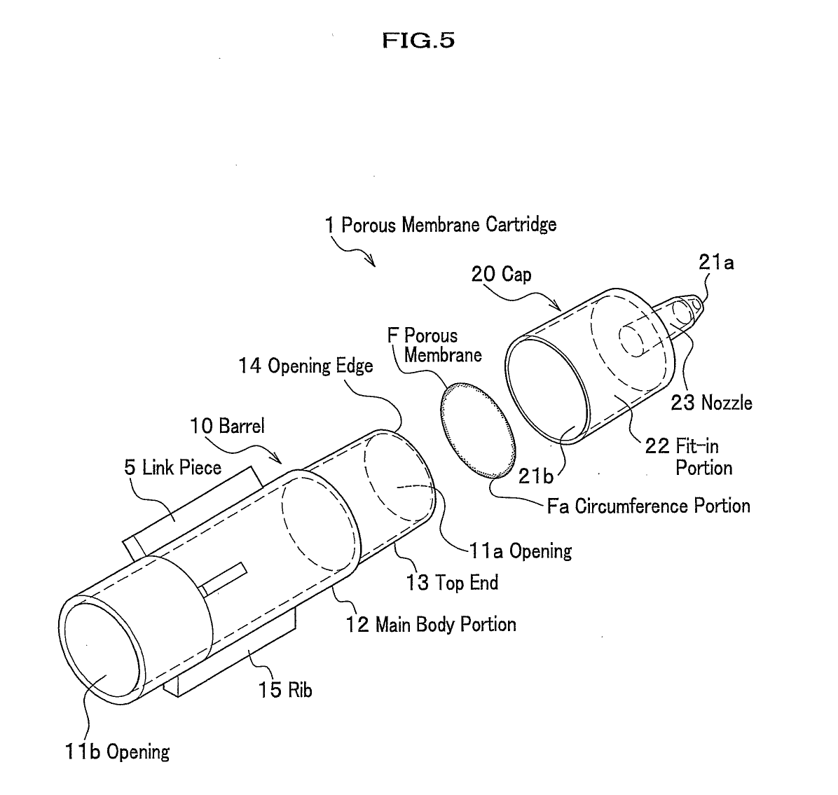

As shown in FIGS. 1 (a) to (c), in a multiple cartridge A related to the best mode for embodying the present invention, eight multiple cartridges 1 are linked side by side by link pieces 5, respectively. The link pieces 5 are composed of a resin such as sheet-form polypropylene. Meanwhile, in the best mode for embodying the present invention, a side of the multiple cartridge A (barrel 10 and cap 20) where liquid flows in is called a rear end side, and a side thereof where the liquid is pushed out is called a top end side. As shown in FIG. 5, the porous membrane cartridge 1 comprises a porous membrane F and the barrel 10 and cap 20 that hold the porous membrane F and form a passage where liquid passes. In addition, in each porous membrane cartridge 1 of both ends of the multiple cartridge A is formed a rib 15 at a position separated by approximately 135 degrees in a horizontal direction for the link piece 5. The rib 15 abuts with an upper portion of a cartridge array frame B described later where the multiple cartridge A is inserted.

The barrel 10 comprises a cylindrical main body portion 12 and a cylindrical top end portion 13 connected to other barrels 10 (porous membrane cartridges 1) and the main body portion 12, and further comprises an opening 11a at the top end portion 13 and an opening 11b at the rear end portion of the main body portion 12. Therefore, liquid can pass from the opening 11b to the opening 11a. An outer diameter of the top end portion 13 is designed to be one size smaller than that of the main body portion 12. In addition, a thickness of the barrel 10 is preferably not less than 0.5 mm.

As shown in FIG. 5, the cap 20 comprises a cylindrical fit-in portion 22 and a nozzle 23 connected to a top end side of the fit-in portion 22.

At a top of the nozzle 23 is formed an opening 21a, also at a rear end of the fit-in portion 22 is formed an opening 21b, and thus liquid can pass from the rear end side toward top end side of the cap 20. A thickness of the nozzle 23 is preferably not less than 0.5 mm.

An inner diameter of the fit-in portion 22 is formed to be a diameter that can fit the outer diameter of the top end portion 13 of the barrel 10.

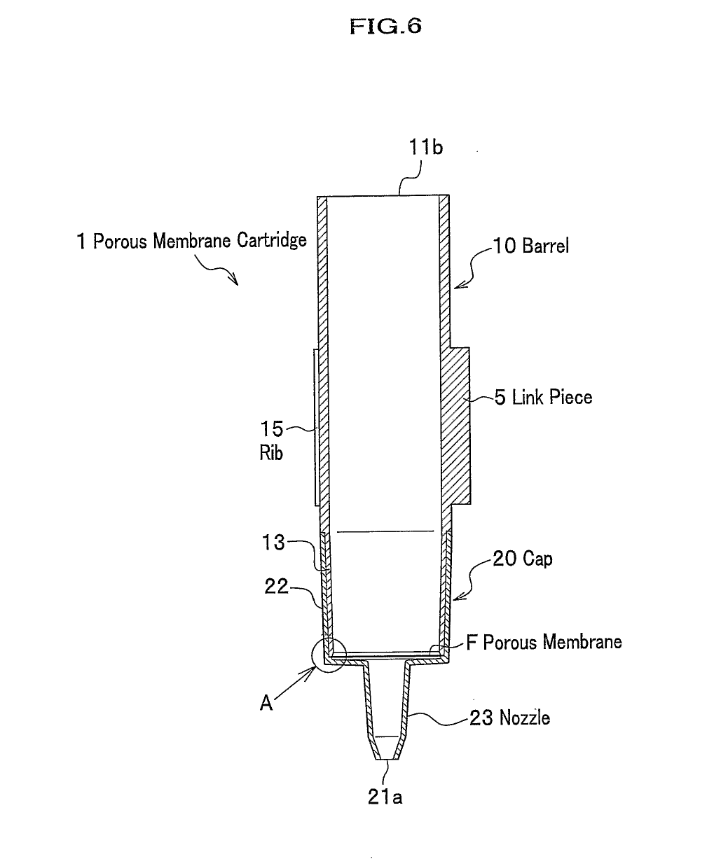

And as shown in FIG. 6, by fitting the top end portion 13 of the barrel 10 in the fit-in portion 22 of the cap 20 in a state of the porous membrane F being kept inside the fit-in portion 22 of the cap 20, the porous membrane F can be sandwiched between the cap 20 and the barrel 10.

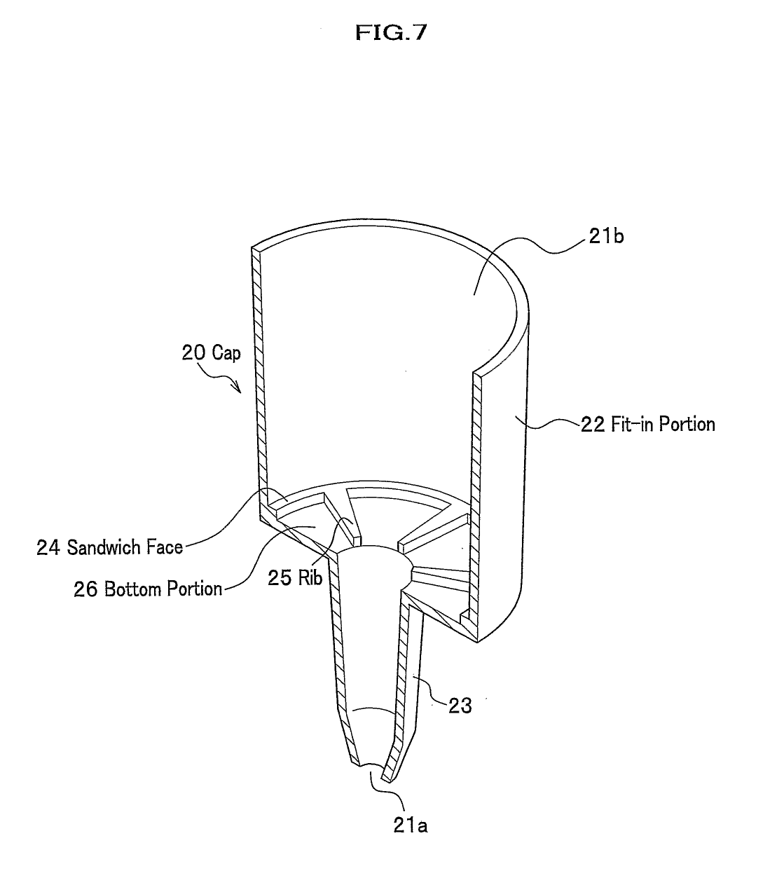

As shown FIG. 7, in the cap 20 are formed six (only three shown) radial ribs 25 at a bottom portion 26 of the fit-in portion 22 connected to the nozzle 23 through the fit-in portion 22. In addition, at an outer circumferential edge of the bottom portion 26 is circumferentially formed a sandwich face 24, which is higher by one step than the bottom portion 26 so as to be a same height as an upper face of the ribs 25.

The sandwich face 24 is a face for sandwiching the porous membrane F between itself and the opening edge 14 (see FIG. 5) corresponding to an edge of the opening 11a of the barrel 10.

The ribs 25 are formed to be the same height as the sandwich face 24, thereby support the porous membrane F arranged at the bottom portion 26 within the cap 20, and prevent the porous membrane F from elongating and breaking by a liquid flow from the rear end (opening 21b) to the top end (opening 21a). In addition, the ribs 25 are radially formed, and thereby liquid is designed to smoothly flow into the nozzle 23 when making the liquid flow from the top end to the rear end.

Meanwhile, although the barrel 10 and the cap 20 are composed, for example, of polypropylene, it is not limited thereto. When fixng the barrel 10 and the cap 20 by ultrasonic deposition, a thermoplastic resin where the ultrasonic deposition can be applied is available. In addition, when fixing them by an adhesive, a material that can be adhered by the adhesive is available.

The porous membrane F is a porous membrane composed of an organic polymer and is formed to be a circular form approximately matching the inner diameter of the cap 20 and the outer diameter of the top end portion 13 of the barrel 10. As a material of the porous membrane F is suitable, for example, a surface saponification matter of an acetylcellulose. As the acetylcellulose, although any of a mono-acetylcellulose, di-acetylcellulose, and tri-acetylcellulose is available, the tri-acetylcellulose is especially desirable.

Meanwhile, as a general filter can also be used a porous membrane composed of PTFE (polytetrafluoroethylene), polyamide, polypropylene, polycarbonate, and the like.

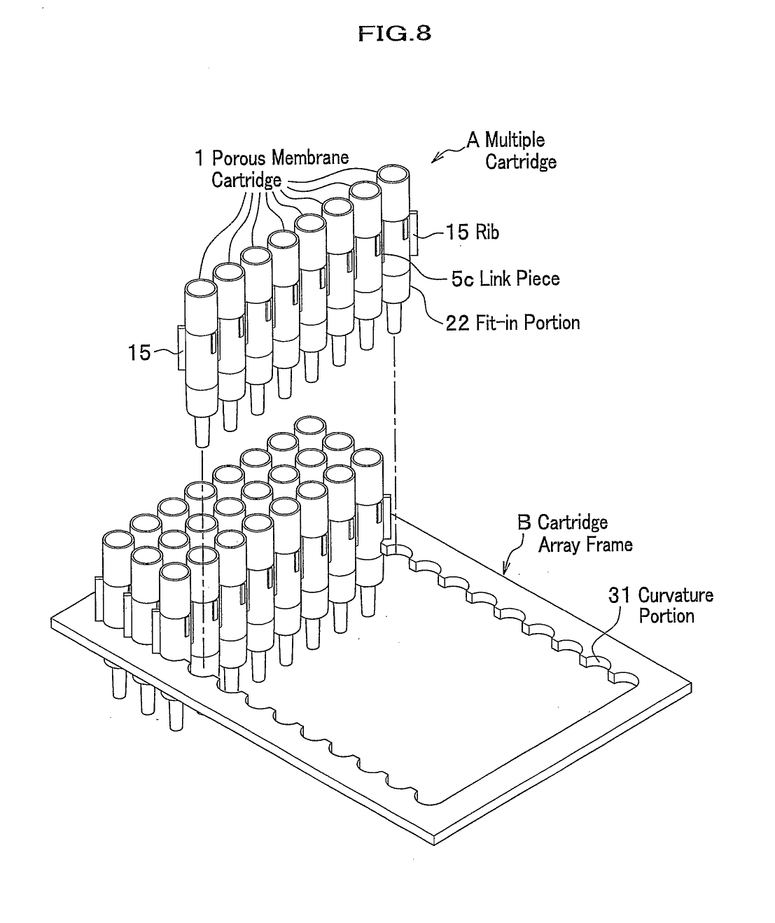

Next will be described the cartridge array frame B related to the best mode for embodying the present invention, referring to FIG. 8. The cartridge array frame B is a rectangular frame body. On one pair of inside faces of the cartridge array frame B are formed curvature portions 31 for fitting in side faces of the multiple cartridge A. Meanwhile, the cartridge array frame B is held by a holding mechanism not shown. Here, the curvature portions 31 correspond to the holding portions described in “DISCLOSURE OF THE INVENTION.”

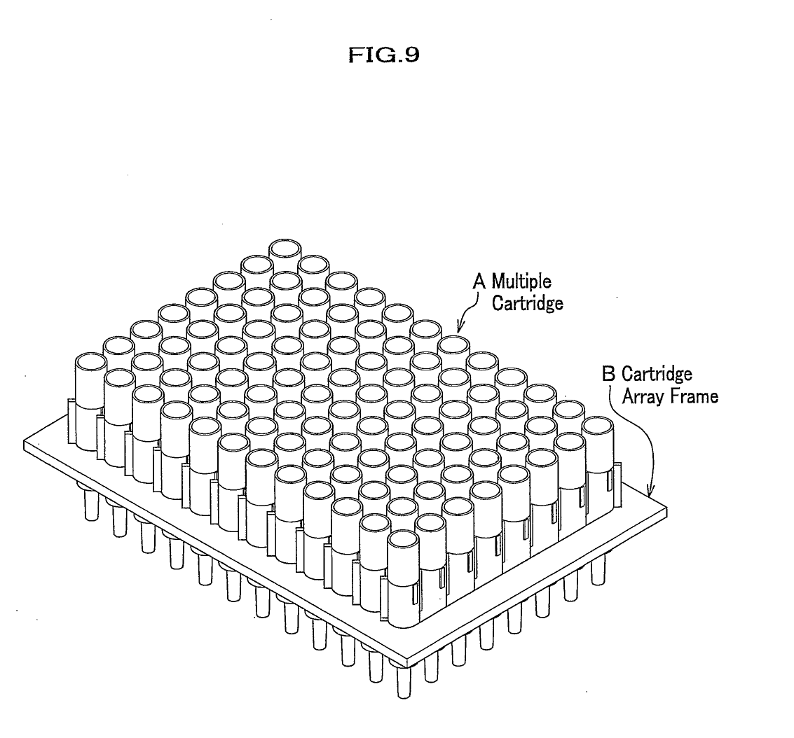

As shown in FIGS. 8 and 9, the multiple cartridge A fits in the cartridge array frame B. The fit-in portions 22 of the multiple cartridge A fit in the curvature portions 31 of the cartridge array frame B. The ribs 15 of the multiple cartridge A abut with the upper portion of the cartridge array frame B.

The multiple cartridge A is used as follows:

Firstly, as sample solutions, prepare body fluids such as a whole blood, plasma, serum, urine, human waste, semen, and saliva taken as analytes; or solutions adjusted from biotic materials such as a soluble matter and homogenate of a vegetable (or its part), an animal (or its part), and the like. Treat these solutions with a water solution containing a reagent, which solves a cell membrane and solubilizes nucleic acids. Thus the cell membrane and a nucleic membrane are solved, and the nucleic acids are dispersed in the water solution. For example, when a sample is a whole blood, red blood cells and various proteins are removed and white blood cells and nucleic membranes are solved by incubation of 10 minutes at 60 degrees Celsius in a state of addition of Guanidine Hydrochloride, Triton-X100, and Protease K (manufactured by SIGMA Corp.).

A sample solution is completed by adding a water soluble organic solvent, for example, ethanol in the water solution where the nucleic acids are thus dispersed. Pass the sample solution toward the opening 21a of the top end of the nozzle 23 from the opening 11b of the rear end side of the porous membrane cartridge 1. Thus the nucleic acids in the sample solution are adsorbed by the porous membrane F.

Next, pass a nucleic-acid-washing buffer solution toward the opening 21a of the nozzle 23 from the opening 11b of the rear end side of the porous membrane cartridge 1. Although the nucleic-acid-washing buffer solution does not desorb nucleic acids adsorbed on the porous membrane F, it has a composition of desorbing impurities and consists of a solution containing a main agent and a buffer agent, and a surfactant as needed. As the main agent is preferable a solution containing ethanol, Tris, and Triton-X100. By this operation, from the porous membrane F are removed impurities other than the nucleic acids.

Next, pass purification distilled water, TE buffer, or the like toward the opening 21a (see FIG. 5) from the opening 11b, desorb and flow the nucleic acids out of the porous membrane F, and recover a solution containing nucleic acids that have flowed out.

In accordance with the best mode for embodying the present invention, because the multiple cartridge A can appropriately change a use number of the porous membrane cartridges 1, the cartridges 1 not used do not wastefully occur by using the multiple cartridge A configured of the porous membrane cartridges 1 depending on the use number thereof, and thus a waste thereof can be prevented.

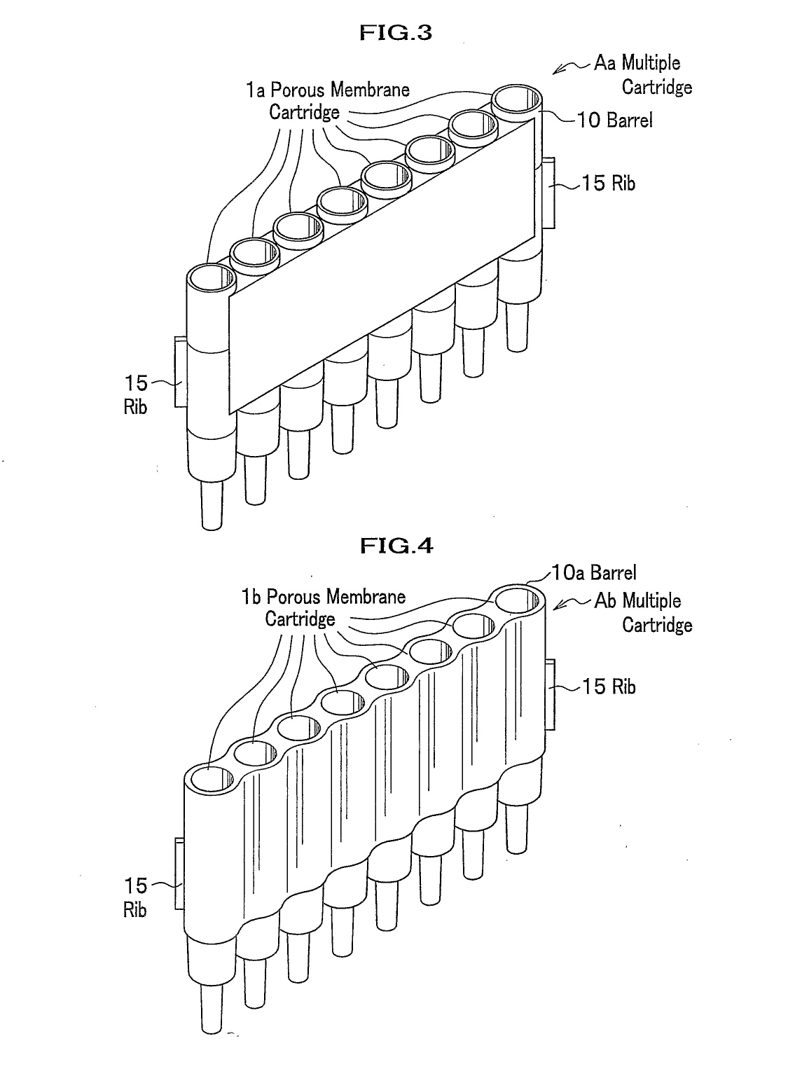

In the best mode for embodying the present invention, although the porous membrane cartridges 1 for configuring the multiple cartridge A are linked by the link pieces 5, it is also available, as shown in FIG. 3, to make the barrels 10 of porous membrane cartridges 1a of a multiple cartridge Aa abut each other and to make the abutment portions thick. In addition, it is also available, as shown in FIG. 4, to integrally mold a barrel 10a of porous membrane cartridges 1b of a multiple cartridge Ab. In addition, in the best mode for embodying the present invention, although the porous membrane cartridges 1 for configuring the multiple cartridge A are linked by the link pieces 5, the caps 20 may also be linked by the link pieces 5; the caps 20 are made to abut each other, and the abutment portions may also be made thick; and in addition, a cap thereof may also be integrally molded.

In addition, in the best mode for embodying the present invention, although the multiple cartridge A is configured of the eight porous membrane cartridges 1, it may be configured of a plurality of porous membrane cartridges 1, and, for example, any of four, six, and twelve porous membrane cartridges 1 may also be configured side by side in a row.

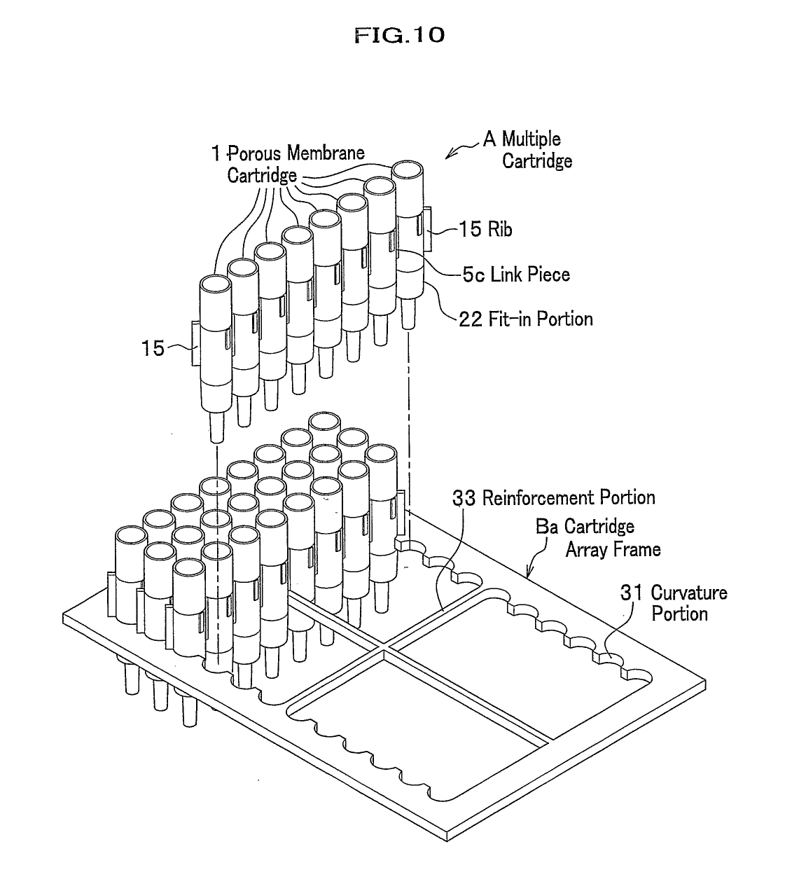

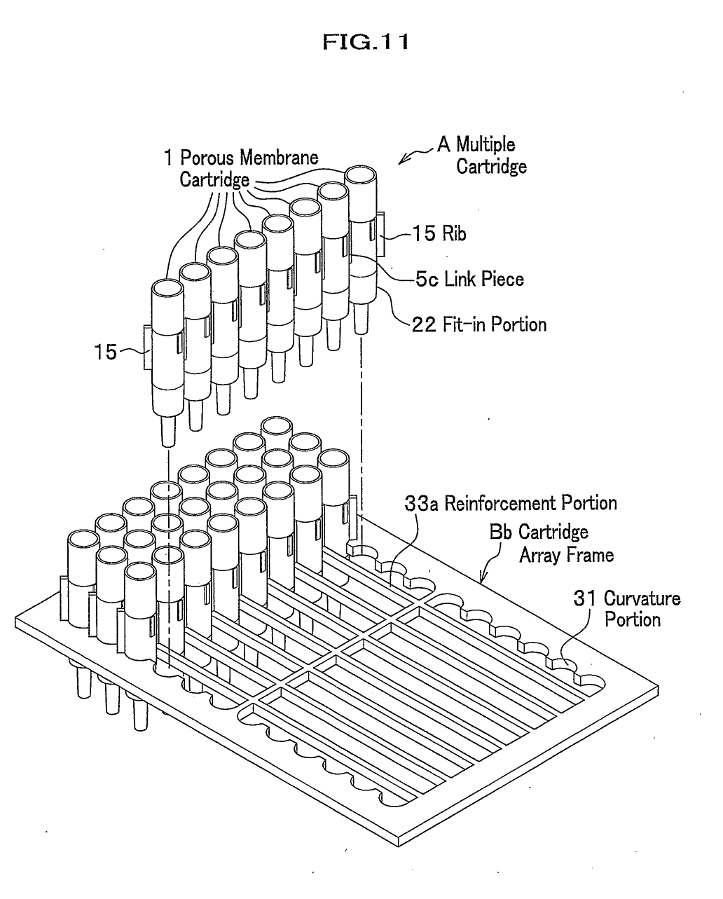

In addition, as shown in FIG. 10, a cross-form reinforcement portion 33 may also be provided inside a cartridge array frame Ba; as shown in FIG. 11, reinforcement portions 33a provided inside one pair of sides of a cartridge array frame Bb may also be arrayed for every link piece 5c of the multiple cartridge A. In addition, a holding portion of a cartridge array frame may also be a lattice form. In addition, a holding portion of a cartridge array frame may also be formed at one pair of sides thereof. Furthermore, the present invention is not limited to the technologies described in the best mode for embodying the invention: it goes without saying that as far as a spirit and creation of technologies are same, they are included in the technical scope of the invention.

### INDUSTRIAL APPLICABILITY

In accordance with the present invention, because a multiple cartridge of the invention can appropriately change a use number of porous membrane cartridges, the porous membrane cartridges not used do not wastefully occur by using the multiple cartridge configured of the porous membrane cartridges depending on the use number thereof, and thus a waste thereof can be prevented. In addition, it is not troublesome to insert the multiple cartridge in a frame thereof, and a simple structural frame can be obtained for inserting the porous membrane cartridges.

1. A multiple cartridge comprising:
a plurality of porous membrane cartridges for holding each porous membrane within a tube of a tubular body thereof, said plurality of porous membrane cartridges being provided side by side in a row and integrally configured,
wherein said tubular body has an opening at a top end portion and rear end portion thereof.

2. A multiple cartridge of claim 1, wherein said porous membrane cartridge comprises:
a tubular barrel having each opening at a top end portion and rear end portion thereof;
a cap that is formed like a tube having a fit-in portion for fitting outside said top end portion, abuts with an opening edge of said top end portion, and has a sandwich face for sandwiching a porous membrane between the cap and said barrel;
and said porous membrane sandwiched between said opening edge of said barrel and said cap.

3. A multiple cartridge of claim 1, wherein an adjacent portion of each said porous membrane cartridge is linked by a link piece along a longitudinal direction of said tubular body.

4. A multiple cartridge of claim 2, wherein an adjacent portion of each said porous membrane cartridge is linked by a link piece along a longitudinal direction of said barrel or said cap.

5. A multiple cartridge of claim 1, wherein a connection portion of each said porous membrane cartridge is thickly formed.

6. A multiple cartridge of claim 1, wherein each adjacent said tubular body is integrally molded.

7. A multiple cartridge of claim 2, wherein each adjacent said barrel or each adjacent said cap is integrally molded.

8. A cartridge array frame for arraying a multiple cartridge of claim 1, the frame comprising:
a frame body having a rectangular opening, whose one pair of sides corresponds to a length in a horizontal direction of said multiple cartridge; and
a plurality of holding portions that are provided inside the other pair of sides of said opening and hold side portions of said multiple cartridge.

9. A multiple cartridge of claim 2, wherein a connection portion of each said porous membrane cartridge is thickly formed.

10. A cartridge array frame for arraying a multiple cartridge of claim 2, the frame comprising:
a frame body having a rectangular opening, whose one pair of sides corresponds to a length in a horizontal direction of said multiple cartridge; and
a plurality of holding portions that are provided inside the other pair of sides of said opening and hold side portions of said multiple cartridge.

11. A cartridge array frame for arraying a multiple cartridge of claim 3, the frame comprising:
a frame body having a rectangular opening, whose one pair of sides corresponds to a length in a horizontal direction of said multiple cartridge; and
a plurality of holding portions that are provided inside the other pair of sides of said opening and hold side portions of said multiple cartridge.

12. A cartridge array frame for arraying a multiple cartridge of claim 4, the frame comprising:
a frame body having a rectangular opening, whose one pair of sides corresponds to a length in a horizontal direction of said multiple cartridge; and
a plurality of holding portions that are provided inside the other pair of sides of said opening and hold side portions of said multiple cartridge.

13. A cartridge array frame for arraying a multiple cartridge of claim 5, the frame comprising:
a frame body having a rectangular opening, whose one pair of sides corresponds to a length in a horizontal direction of said multiple cartridge; and
a plurality of holding portions that are provided inside the other pair of sides of said opening and hold side portions of said multiple cartridge.

14. A cartridge array frame for arraying a multiple cartridge of claim 6, the frame comprising:
a frame body having a rectangular opening, whose one pair of sides corresponds to a length in a horizontal direction of said multiple cartridge; and
a plurality of holding portions that are provided inside the other pair of sides of said opening and hold side portions of said multiple cartridge.

15. A cartridge array frame for arraying a multiple cartridge of claim 7, the frame comprising:
a frame body having a rectangular opening, whose one pair of sides corresponds to a length in a horizontal direction of said multiple cartridge; and
a plurality of holding portions that are provided inside the other pair of sides of said opening and hold side portions of said multiple cartridge.
